(19) United States
(12) Patent Application Publication
(10) Pub. No.: US 2006/0254787 A1
(43) Pub. Date: Nov. 16, 2006

(54) Limit structure for a hook of a pneumatic tool

(75) Inventor: Chun-Chi Lai, Taichung City (TW)

Correspondence Address: John S. Egbert;Harrison & Egbert, 7th Floor, 412 Main Street, Houston, TX, 77002, US

(73) Assignee: BASSO INDUSTRY CORP., Taichung City (TW)

(21) Appl. No.: 11/129,075

(22) Filed: May 16, 2005

(51) Int. Cl. B25D 17/04

(52) U.S. Cl. 173/171

(57) ABSTRACT

The limit structure for the hook of the pneumatic tool, and the area that is preset on the pneumatic tool has a cylinder hook assembly part that can be covered by a loop cover of the hook. A ring groove is placed on the circumferential area of the hook assembly part, and radial through holes are located at two radial spaced locations on the loop cover, so the center line of the through hole can pin through the ring groove. The through fixer goes through the radial through hole and through the corresponding ring groove, and the hook reaches the combination of limit state that is rotatable by locking the middle of these two through fixers in the ring groove. With this structure, it helps the limit structure for the hook of the pneumatic tool to achieve practical effects of simpler production and more convenient assembling.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a pneumatic tool, and more particularly to its hook with a limit structure.

### BACKGROUND OF THE INVENTION

In response to users' demand, the current pneumatic tool (such as pneumatic handle, pneumatic gun) is added with hook in convenience of hanging the pneumatic tool. However, under some circumstances, the hook is not needed, therefore, there are many hooks for pneumatic tools are designed with assembled or disassembled options.

The structure that present invention desires to improve is the limit structure of the hook mentioned above. The conventional design puts a stepped cylinder at the area that is prepared for the hook of the pneumatic tool, so that a loop cover of the hook may be placed pivotally over the cylinder. A screw clamping ring is made to be screwed onto the end of the cylinder of the pneumatic tool, and by blocking one side of the loop cover to achieve the purpose of limiting the hook. Except, this conventional structure still has the following issues in practical application.

1. From a manufacturing point of view, because the screw clamping ring and the cylinder part of the pneumatic tool has the spiral part that can be time consuming during the manufacturing process, which creates the disadvantages, such as higher cost of manufacturing, and it does not meet the preferred industrial practicality.

2. From an assembling point of view, the assembling of the screw clamping ring must be screwed on to achieve the desired position; therefore, the process is slower and less effective.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

1. The main objective of the limit structure of the hook of the pneumatic tool disclosed in the present invention is to achieve the pinned position by the unique design of pinning the through fixers to the ring groove and radial through hole that is placed correspondingly to the loop cover and hook assembly part of the pneumatic tool. And by this design, the purpose can be achieved by the simple structure of hole, pin and ring groove, and the manufacturing process is simpler and faster, which meets the preferred industrial practicability of simplifying the production and reducing the cost.

2. Another objective of the present invention is to improve the disadvantage of the screwing method by the new design of pinning method of the through fixer, which greatly improves the efficacy of the assembly.

3. Another objective of the present invention is to make the second end of the through fixer ring groove like for an elastic ring cover to connect to, so that the through fixer has the advantage of fast disassembly in convenience of disassembling the hook in the future.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the hook and pneumatic tool of the present invention.

FIG. 2 shows an exploded perspective view of the hook and pneumatic tool of the present invention.

FIG. 3 shows an exploded cutaway view of the hook and pneumatic tool of the present invention.

FIG. 4 shows an assembled vertical cutaway view of the hook and pneumatic tool of the present invention.

FIG. 5 shows an assembled horizontal cutaway view of the hook and pneumatic tool of the present invention.

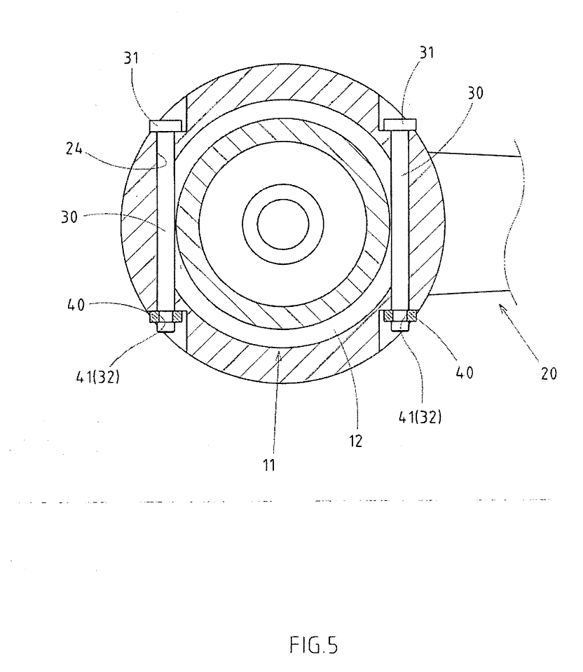

FIG. 6 shows another embodiment of the through fixer of the present invention.

FIG. 7 shows another embodiment of the through fixer of the present invention.

FIG. 8 shows another embodiment of the structure of the present invention.

FIG. 9 shows another embodiment of the structure of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

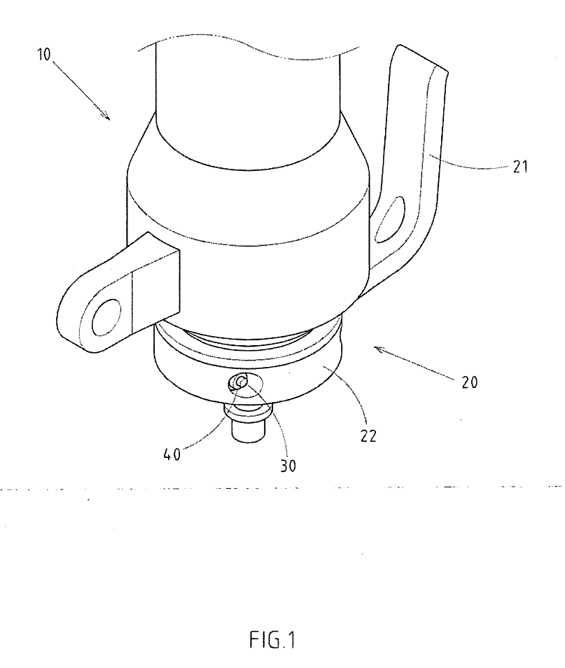

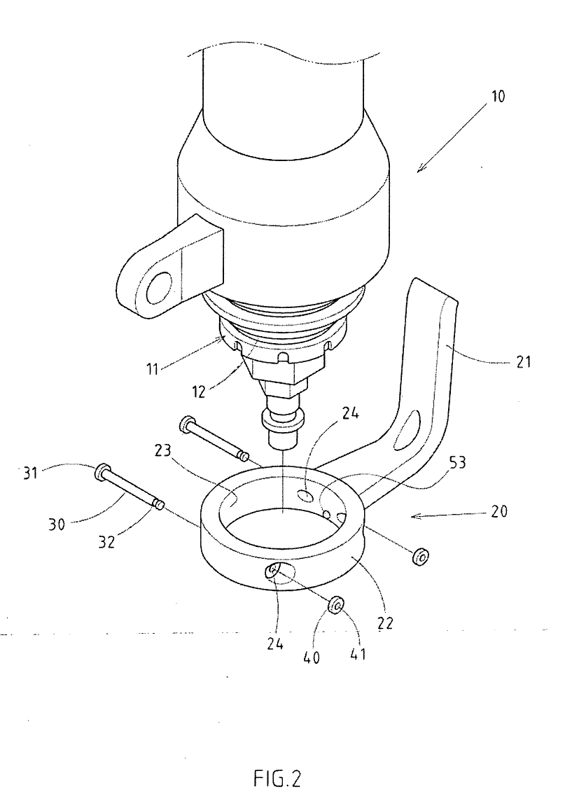

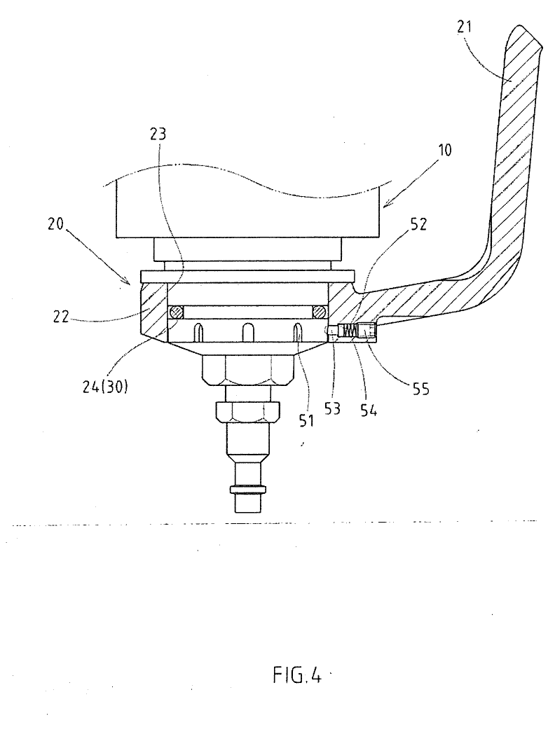

As shown in FIGS. 1-4, a limit structure for the hook of a pneumatic tool structure embodied in the present invention comprises:

a pneumatic tool body 10, which can be any hand tool that is pneumatic, such as pneumatic handle, pneumatic gun;

A hook assembly part 11 is the cylinder shaped area that is preset on the pneumatic tool body 10.

A ring groove 12 is located on the circumferential area of the hook assembly part 11.

A hook 20 includes a hanger 21 and a loop cover 22; among them, the center of the loop cover 22 has a slip hole 23 that can be pinned from outside the hook assembly part 11.

Two radial through-holes 24 are located at two radial spaced locations on the loop cover 22 of the hook 20, and the center line of these two radial through holes 24 go through the two corresponding sides of the ring groove 12 mentioned above.

Two stick-like through fixers 30 have an expanded end 31 on its first end, and its second end has a limit assembly part 32 for limit part, and this second end pins through the radial through-holes 24 mentioned above and its corresponding ring groove 12. By locking the middle of these two through fixers 30 at the two relative sides of the ring groove 12 separately, the hook 20 reaches the combination of limit state that is rotatable.

Two limit parts 40 are assembled to the limit assembly parts 32 for limit parts mentioned above, and by pinning the through fixers 30 to achieve the positioning, and to prevent them from getting loose.

After the hook of the pneumatic tool disclosed in the present invention is positioned by the through fixers 30 mentioned above, the hook 20 will then be in a 360° rotating condition, and is able to be adjusted to the desired angle according to the user's need.

Among them, the limit assembly parts 32 for limit part on the second end of the through fixers 30 mentioned above are better shaped like a ring groove, so that the limit part 40 mentioned above, which is made of elastic ring cover (can be rubber material), can be positioned by tightly binding the limit assembly part 32 for limit part to the slip hole 41 of the limit part 40. On the other hand, when the user desires to disassemble the through fixer 30, it can be achieved by taking apart the limit part 40 forcefully to disassemble the through fixers 30, which is an advantage of speed disassembly.

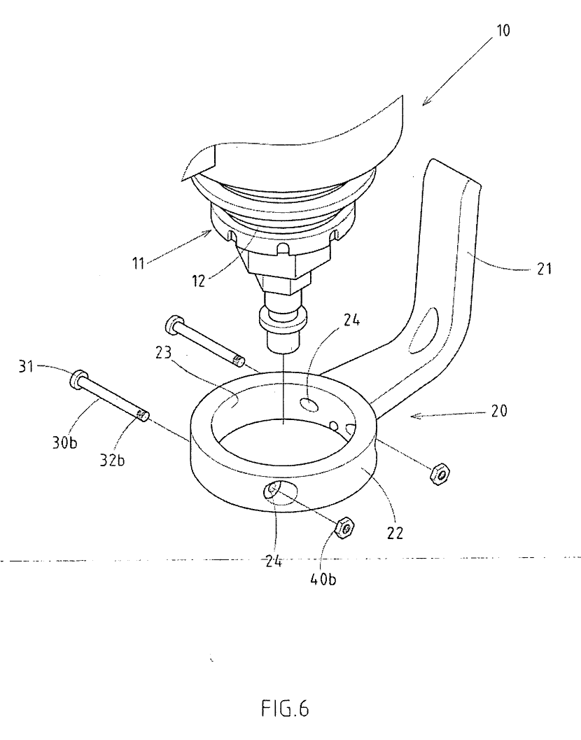

As shown in FIG. 6, which is another embodiment of the through fixer mentioned above, the limit assembly part 32b for the limit part on the second end of the through fixer 30b shown in the figure is a spiral type end, therefore, the limit part 40b is a nut.

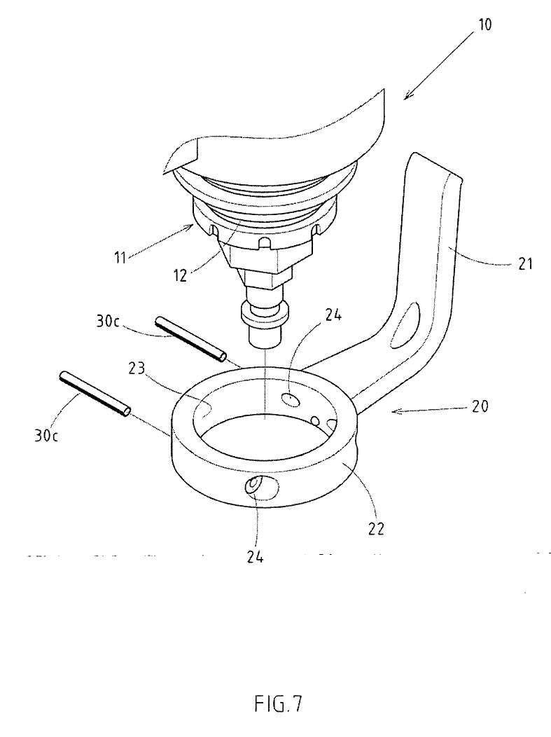

As shown in FIG. 7, which is another embodiment of the through fixer mentioned above, the through fixer 30c shown in the figure is a pin, by tightly pinning and securing it to the radial through hole 24 of the loop cover 22 of the hook 20 to achieve the same effect of the limit hook 20.

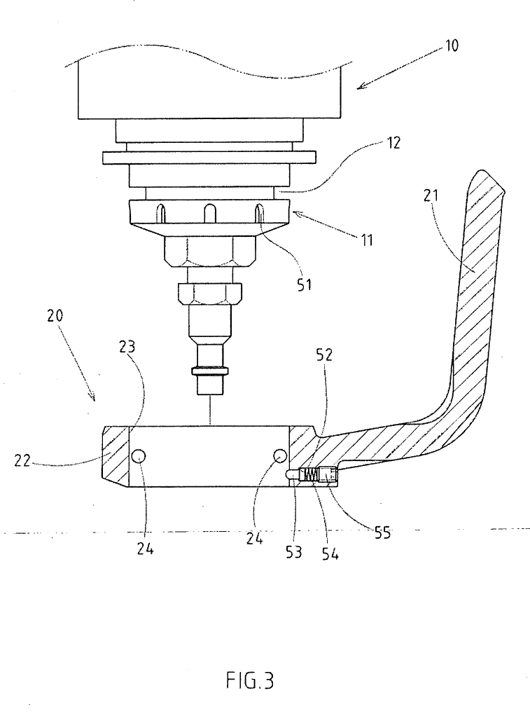

Among these, the space between the loop cover 22 of the hook 20 and the hook assembly part 11 of the pneumatic tool body 10 can be structured with positioning components, and to make the hook turn to achieved the positioning effect; please see FIG. 3, 4, and the positioning components mentioned above can include the followings:

Several fixing edges 51 are located on the edge of the hook assembly part 11.

A containment hole 52 is located radially on one side of the loop cover 22 of the hook 22.

A fixing axle 53 can be inserted into the inner end of the containment hole 52, and by so doing, the fixing edge 51 mentioned above is locked.

A spring 54 is to support the fixing axle 53.

A limit bolt 55 is to be screwed onto the outer end of the containment hole 52 to position the fixing axle 53 and spring 54.

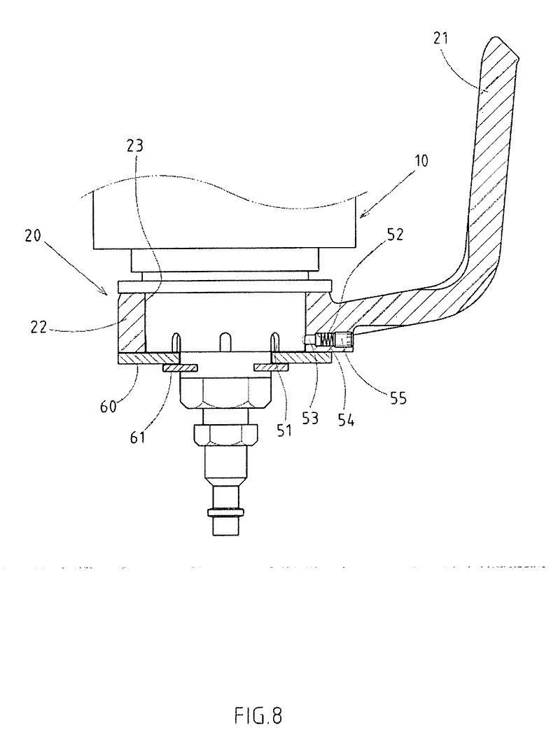

Among these, as shown in FIG. 8, which is another embodiment of the structure of the present invention. The difference between this structure and the embodiment mentioned above is the hook assembly part 11 of the pneumatic tool body 10 is linked to a supporting ring 60 at the bottom after it is connected to the loop cover 22 of the hook. The supporting ring 60 is limited by connecting to a locking ring 61 at the bottom of the supporting ring, and it indirectly limits this hook 20.

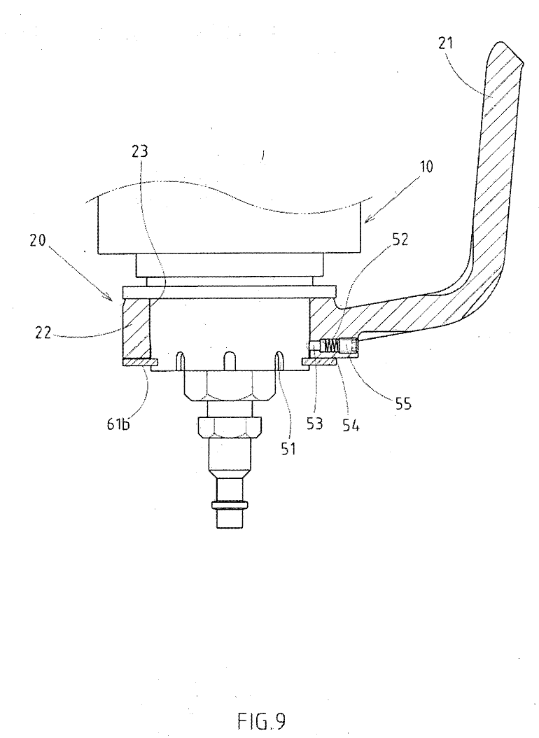

Among these, as shown in FIG. 9, which is another embodiment of the structure of the present invention, and is the modified embodiment of structure mentioned in the preceding paragraph. Its characteristic is the hook assembly part 11 of the pneumatic tool body 10 is directly connected to a linking ring 61b at the bottom after it is connected to the loop cover 22 of the hook, and by so doing to achieve the purpose of limiting the hook 20 directly.

1. A limit structure for a hook of a pneumatic tool, an area prepared for the hook on the pneumatic tool includes comprising a hanger, and a limited position; said limit structure comprising:
a hook assembly part having a cylinder shaped area preset on a body of said pneumatic tool;
a ring groove located on a circumferential area of the hook assembly part;
a loop cover located on another end of the hanger of the hook, the loop cover having a slip hole pinned from outside the hook assembly part;
at least a radial through hole located at an area prepared for the loop cover, a centerline of the radial hole pinning through said ring groove; and
at least a she stick-like through fixer, pinning the radial through hole and corresponding ring groove, by locking a middle of the through fixer in the ring groove, the hook reaching combination of a rotatable limit state.

2. The structure defined in claim 1, wherein said through fixer is comprised of a secured structure.

3. The structure defined in claim 1, wherein said through fixer is comprised of a structure that disassembles.

4. The structure defined in claim 3, wherein said through fixer having a disassembled structure comprises:
a first end of the through fixer having an expanded end, and
a second end having a limit assembly part for a limit part; and
a limit part connectable to the limit assembly part for the limit part to position the through fixer.

5. The structure defined in claim 4, wherein said limit assembly part for limit part is shaped like a ring groove, the limit part being an elastic ring cover and positioned by tightly binding a slip hole of the elastic ring cover in the ring groove.

6. The structure defined in claim 1, wherein space between the loop cover of the hook and the hook assembly part of the pneumatic tool body is structured with positioning components, the hook turn achieving a positioning effect.

7. A limit structure for a hook of a pneumatic tool, an area prepared for the hook on the pneumatic tool comprising a hanger, and a limited position; said limit structure comprising:
a hook assembly part having cylinder shaped area preset on a body of the pneumatic tool;
a loop cover located on another end of the hanger of the hook, the loop cover having a slip hole pinned to the hook assembly part; and
a linking ring connected directly to a bottom of the loop cover achieving limiting the hook.
